(19) United States
(12) Patent Application Publication
(10) Pub. No.: US 2016/0142862 A1
(43) Pub. Date: May 19, 2016

(54) TECHNIQUES FOR EFFECTUATING A NEAR-FIELD COMMUNICATION SESSION

(71) Applicant: Google Inc., (US)

(72) Inventors: Martijn Franciscus Agnes Coenen, Santa Clara, CA (US); Rachel Leah Garb, Mountain View, CA (US); Jeffrey William Hamilton, Austin, TX (US); Robert William Hamilton, Santa Clara, CA (US); Nicholas Julian Pelly, San Francisco, CA (US)

(73) Assignee: GOOGLE INC., Mountain View, CA (US)

(21) Appl. No.: 13/648,382

(22) Filed: Oct. 10, 2012

Related U.S. Application Data
(60) Provisional application No. 61/548,034, filed on Oct. 17, 2011.
(60) Provisional application No. 61/548,000, filed on Oct. 17, 2011.

(51) Int. Cl. H04W 4/00; H04B 5/02; H04W 4/02

(52) U.S. Cl. CPC H04W 4/008; H04W 4/023; H04B 5/0043; H04B 5/02; H04B 5/0031

(57) ABSTRACT

A computer-implemented method can include establishing, at a mobile computing device having a processing device, a near-field communication (NFC) session with a second device when the second device is within a communication range of the mobile computing device. When the second device is determined to have exited the communication range of the mobile computing device, the method can a) interrupt the NFC session, b) determine a reentry direction to move the mobile computing device in relation to the second device in order to bring the second device back within the communication range, c) start a timer, d) determine whether the second device reenters the communication range before the timer exceeds a threshold, and e) provide an instruction to a user to move the mobile computing device in the reentry direction when the second device has not reentered the communication range and the timer exceeds the threshold.

### CROSS-REFERENCE TO RELATED APPLICATIONS

This application claims the benefit of U.S. Provisional Application Nos. 61/548,034 and 61/548,000, filed on Oct. 17, 2011. The disclosures of the above applications are incorporated herein by reference in their entirety.

### FIELD

The present disclosure is directed to techniques for effectuating a near field communication session between a mobile computing device and another device.

### BACKGROUND

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

Mobile computing devices (mobile phones, tablet computers, laptop computers, etc.) can be configured to perform near-field communication (“NFC”) with other devices. The other devices can include “active devices,” such as mobile computing devices and stationary computing devices, or “passive devices,” such as NFC tags, NFC stickers, and key fobs. A user of a mobile computing device can initiate an NFC session by physically touching the mobile computing device to another device or bringing the mobile computing device into close proximity with the other device, e.g., four centimeters or less. Once an NFC session is initiated, the mobile computing device can transmit data to and/or receive data from the other device.

### SUMMARY

A computer-implemented method is disclosed. The method can include establishing, at a mobile computing device having a processing device, a near-field communication (NFC) session with a second device when the second device is within a communication range of the mobile computing device. The method can further include determining, at the mobile computing device, whether the second device has exited the communication range of the first device. When the second device is determined to have exited the communication range of the mobile computing device, the method can include: a) interrupting, at the mobile computing device, the NFC session, b) determining, at the mobile computing device, a reentry direction to move the mobile computing device in relation to the second device in order to bring the second device back within the communication range, c) starting, at the mobile computing device, a timer, d) determining, at the mobile computing device, whether the second device reenters the communication range before the timer exceeds a threshold, and e) providing, at the mobile computing device, an instruction to a user to move the mobile computing device in the reentry direction when the second device has not reentered the communication range and the timer exceeds the threshold.

In some embodiments of the present disclosure, the method can further include reestablishing, at the mobile computing device, the NFC session when the second device reenters the communication range before the timer exceeds the threshold. Additionally, the method can include establishing, at the mobile computing device, a new NFC session with the second device when the second device reenters the communication range after the timer exceeds the threshold. The reentry direction can be determined based on a signal strength at an NFC transceiver of the mobile computing device when the second device exits the communication range. In some embodiments, the reentry direction can be further based on an acceleration signal output by an accelerometer of the mobile computing device, the accelerometer signal being indicative of an exiting direction of the mobile computing device when the second device exits the communication range. The reentry direction may be set equal to a direction that is substantially opposite to the exiting direction.

In various embodiments, the NFC transceiver can include a first NFC antenna and a second NFC antenna, and the signal strength at the NFC transceiver includes a first signal strength at the first NFC antenna and a second signal strength at the second NFC antenna. In these embodiments, the reentry direction can be based on the first signal strength, the second signal strength, and a distance between the first NFC antenna and the second NFC antenna. Additionally, determining the reentry direction can include determining an exiting direction of the mobile computing device based on changes in at least one of the first signal strength and the second signal strength when the second device exits the communication range, the reentry direction being a direction that is substantially opposite to the exiting direction. Further, the instruction can be provided as localized haptic feedback, such that providing the instruction includes: determining, at mobile computing device, a section of the mobile computing device at which to provide the localized haptic feedback based on the reentry direction; and providing, at the mobile computing device, the localized haptic feedback at the section.

Additionally, a mobile computing device is disclosed. The mobile computing device can include a near-field communication (NFC) transceiver configured to generate an electromagnetic field used to perform NFC with a second device. The mobile computing device can further include an NFC control module. The NFC control module can be configured to establish an NFC session with the second device when the second device is within a communication range of the NFC transceiver. The NFC control module can also be configured to determine whether the second device has exited the communication range of the NFC transceiver. Additionally, The NFC control module can be configured to, when the second device is determined to have exited the communication range of the NFC transceiver: a) interrupt the NFC session, b) start a timer, c) determine whether the second device reenters the communication range before the timer exceeds a threshold, and d) provide an instruction to a user to move the mobile computing device in a direction relative to the other device when the second device has not reentered the communication range and the timer exceeds the threshold. Further the mobile computing device can include a direction determination module configured to determine the reentry direction.

In various embodiments, the NFC control module can be further configured to reestablish the NFC session when the second device reenters the communication range before the timer exceeds the threshold. Additionally, the NFC control module can be further configured to establish a new NFC session with the second device when the second device reenters the communication range after the timer exceeds the threshold. In some embodiments, the direction determination module can determine the reentry direction based on a signal strength at the NFC transceiver when the second device exits the communication range.

The mobile computing device may further include an accelerometer that outputs an accelerometer signal that is indicative of an exiting direction of the mobile computing device when the second device exits the communication range, wherein the direction determination module determines the reentry direction based on the exiting direction. In some embodiments, the reentry direction may be a direction that is substantially opposite to the current direction. The NFC transceiver can include a first NFC antenna and a second NFC antenna, and the signal strength at the NFC transceiver can include a first signal strength at the first NFC antenna and a second signal strength at the second NFC antenna. In these embodiments, the direction determination module can be further configured to determine an exiting direction of the mobile computing device when the second device exits the communication range based on the first signal strength, the second signal strength, and a distance between the first NFC antenna and the second NFC antenna. The reentry direction can be a direction that is substantially opposite to the exiting direction.

The mobile computing device can further include a plurality of vibrators, each vibrator located at a different portion of the mobile computing device. In these embodiments, the NFC control module can provide the instruction to move the mobile computing device in the reentry direction by: selecting one of the plurality of vibrators based on the reentry direction; and commanding the selected vibrator to vibrate.

In various further embodiments, a computer-implemented method is disclosed. The method can include establishing, at a mobile computing device having a processing device, a near-field communication (NFC) session with a second device when the second device is within a communication range of the mobile computing device. The method can further include determining, at the mobile computing device, whether the second device has exited the communication range of the first device. When the second device is determined to have exited the communication range of the mobile computing device, the method can a) interrupt, at the mobile computing device, the NFC session, b) determine, at the mobile computing device, a reentry direction to move the mobile computing device in relation to the second device in order to bring the second device back within the communication range, and c) provide, at the mobile computing device, an instruction to a user to move the mobile computing device in the reentry direction when the second device has not reentered the communication range and the timer exceeds the threshold.

In some embodiments, the method can further include starting, at the mobile computing device, a timer when the second device is determined to have exited the communication range of the mobile computing device. The method can also include determining, at the mobile computing device, whether the second device reenters the communication range before the timer exceeds a threshold. The NFC session may be reestablished, at the mobile computing device, when the second device reenters the communication range before the timer exceeds the threshold. Further, the method may establish, at the mobile computing device, a new NFC session with the second device when the second device reenters the communication range after the timer exceeds the threshold.

Further areas of applicability of the present disclosure will become apparent from the detailed description provided hereinafter. It should be understood that the detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 is a schematic illustration depicting a mobile computing device performing near-field communication with another device according to some embodiments of the present disclosure;

FIG. 2 is a component block diagram depicting example components of the mobile computing device of FIG. 1;

FIG. 3 is a flow chart depicting an example technique for effectuating a near-field communication session according to some embodiments of the present disclosure;

FIG. 4 is a component block diagram depicting the mobile computing device of FIG. 1 configured to provide localized haptic feedback according to some embodiments of the present disclosure;

FIGS. 5A-5D are schematics depicting an example of the two mobile computing devices of FIG. 1 engaged in near-field communication according to some embodiments of the present disclosure;

### DETAILED DESCRIPTION

A near-field communication (“NFC”) session between a mobile computing device and another device may be interrupted when the other device exits the communication range of the mobile computing device. If the other device reenters the communication range of the mobile computing device in a relatively short period of time, e.g., less than 10 seconds, the NFC session may be reestablished. If, however, the other device remains outside of the communication range of the mobile computing device for a prolonged period of time, e.g., more than 10 seconds, the NFC session may be ended and a new NFC session may need to be established to perform further NFC between the devices. Because the communication range for performing NFC is relatively small, the user of the mobile computing device may be unaware that the other device has exited the communication range.

Accordingly, techniques are presented for effectuating NFC sessions between a mobile computing device and another device. When an NFC session is interrupted due to the other device exiting the communication range of the mobile computing device, the techniques can include determining a reentry direction to move the mobile computing device in order for the second device to reenter the communication range. The techniques can further include determining whether the second device has reentered the communication range within a period of time, and if not, providing an instruction to the user to move the mobile computing device in the determined direction.

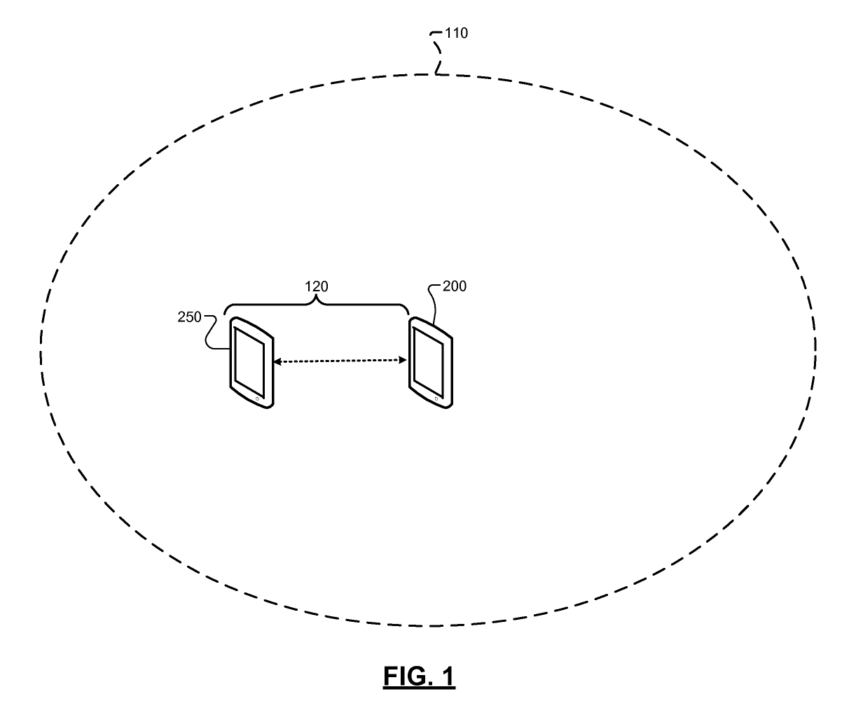

Referring now to FIG. 1, a schematic illustration of a mobile computing device 200 performing NFC with another device 250 is depicted. As shown, the mobile computing device 200 is a mobile telephone. It should be appreciated, however, that the mobile computing device 200 can be any suitable mobile computing device, such as a tablet computer, a laptop computer, a personal digital assistant, a handheld medical device, or a handheld gaming device. Also as shown, the other device 250 is a mobile telephone, but the other device 250 can be any suitable device for performing NFC, including another computing device, a stationary terminal, an NFC tag, a key fob, or an NFC card.

In order to establish an NFC session between the mobile computing device 200 and the other device 250, the mobile computing device 200 (the “initiator”) initiates NFC with the other device 250 (the “target”). To initiate NFC, the mobile computing device 200 can generate and emit an electromagnetic field 110. Data can be communicated between the mobile computing device 200 and the other device 250 via the electromagnetic field 110. When the mobile computing device 200 initiates NFC with the other device 250, the other device 250 can operate in one of an “active mode” or a “passive mode.” In a passive mode, the mobile computing device 200 transmits the electromagnetic field 110 and the other device 250 responds by modulating a payload into the electromagnetic field 110. When operating in the passive mode, the other device 250 may be energized by the electromagnetic field 110. In an active mode, the other device 250 and the mobile computing device 200 can alternate generating the electromagnetic field 110.

While NFC packets can be transmitted between the mobile computing device 200 and the other device 250 at the outer limits of the electromagnetic field 110, reliable NFC cannot be achieved (less NFC packet loss) unless the other device 250 is within a communication range 120 of the mobile computing device 200, e.g., approximately four centimeters. When the other device 250 exits the communication range 120 of the mobile computing device 200, the mobile computing device 200 can interrupt the NFC session. It should be appreciated that the other device 250 exiting the communication range 120 can include a situation when the distance between the mobile computing device 200 and the other device 250 increases such that the other device 250 is no longer within the communication range 120 of the mobile computing device 200. The foregoing includes scenarios where the other device 250 is physically moved away from the mobile computing device 200 and/or where the mobile computing device 200 is physically moved away from the other device 250. When the mobile computing device 200 determines that the other device 250 has exited the communication range 120, the mobile computing device 200 can determine a reentry direction. The term reentry direction can include a direction by which to move the mobile computing device 200 in order for the other device 250 to reenter the communication range 120. The mobile computing device 200 can then provide an instruction to the user to move the mobile computing device 200 in the reentry direction. The instruction can be provided as audible feedback, visual feedback, and/or haptic feedback.

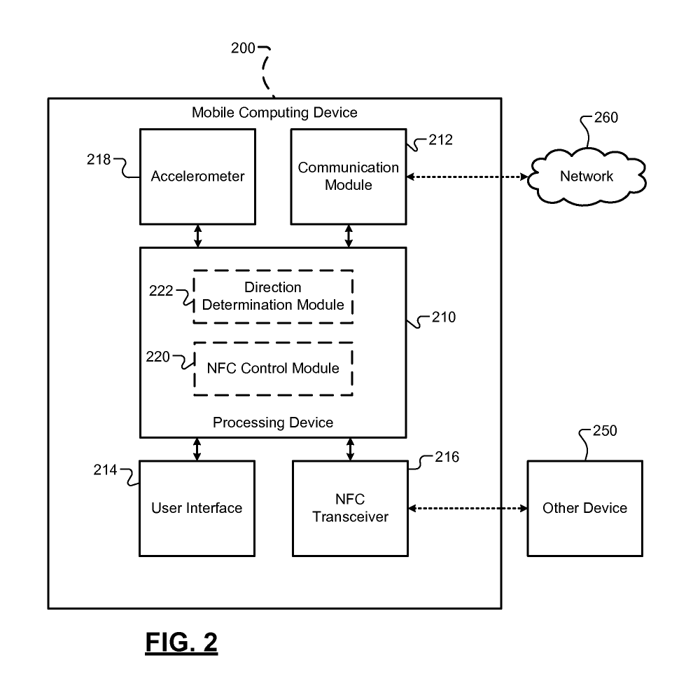

Referring now to FIG. 2, a functional block diagram of the mobile computing device 200 is illustrated. The mobile computing device 200 can include a processing device 210, a communication module 212, a user interface 214, an NFC transceiver 216, and an accelerometer 218.

The processing device 210 includes one or more processors and memory (e.g., random access memory and/or read-only memory). In embodiments where the processing device 210 includes two or more processors, the two or more processors can operate in a parallel or distributed manner. The processing device 210 controls operation of the mobile computing device 200. The processing device 210 can execute functions including, but not limited to, controlling communication between the mobile computing device 200 and the other device 250. The processing device 210 can also wholly or partially execute an NFC control module 220 and a direction determination module 222.

The user interface 214 enables a user to provide input to and/or receive output from the mobile computing device 200. It should be appreciated that while one user interface 214 is shown, the term user interface also includes a plurality of user interfaces. Examples of a user interface 214 include, but are not limited to, a touchscreen display, a physical-QWERTY keyboard, a speaker, a microphone, and a vibrator. The communication module 212 enables communication between the mobile computing device 200 and a network 260 (a cellular network, an intranet, the Internet, etc.). The communication module 212 can be any suitable device for connecting to the network 260 and can include one or more wireless transceivers and/or antennas. The accelerometer 218 can be a device that outputs an accelerometer signal. The accelerometer signal can be indicative of a direction that the mobile computing device 200 is moving.

The NFC transceiver 216 enables NFC with the other device 250. The NFC transceiver 216 can include one or more antennas that are configured to perform NFC transmissions. The NFC transceiver 216 can generate the electromagnetic field 110 and can receive an electromagnetic field generated by the other device 250 (when the other device 250 is operating in an active mode).

The NFC control module 220 can control NFC between the mobile computing device 200 and the other device 250. The NFC control module 220 can initiate NFC with the other device 250 upon receiving a request from a user to establish an NFC session with the other device 250. The request can be provided to the NFC control module 220, for example, when the user taps the mobile computing device 200 to the other device 250 and/or enters a command to begin an NFC session via the user interface 214. Upon receiving the request, the NFC control module 220 can command the NFC transceiver 216 to generate an electromagnetic field 110. The NFC control module 220 can receive a response from the other device 250, which the NFC control module can use to affirm that the other device 250 is able to engage in NFC. Once this occurs, the NFC control module 220 can be said to have established the NFC session.

While the NFC session is established, the NFC control module 220 can transmit data to and/or receive data from the other device 250. In operation, the NFC control module 220 may be provided with a payload (photograph, document, etc.) that is to be transmitted to the other device 250. The NFC control module 220 can packetize the payload into NFC data packets in accordance with an NFC protocol and provide the NFC data packets to the NFC transceiver 216 for transmission to the other device 250. Similarly, the NFC control module 220 can receive NFC data packets from the other device 250 via the NFC transceiver 216 and can decode the NFC data packets in accordance with the NFC protocol.

The NFC control module 220 can also monitor the NFC transceiver 216 to determine whether the other device 250 has exited the communication range 120 of the mobile computing device 200. For example, the NFC control module 220 can monitor the signal strength realized at the NFC transceiver 216. When the signal strength decreases below a threshold, the NFC control module 220 can determine that the other device 250 has exited the communication range 120. The term signal strength can refer to the strength of the electromagnetic field generated by the other device 250 (in an active mode) or to the strength of the electromagnetic field 110 generated by the mobile computing device 200 after it has been modulated by the other device 250 (in a passive mode).

If the other device 250 has exited the communication range 120, the NFC control module 220 can interrupt the NFC session. The NFC control module 220 can interrupt the NFC session by, for example, ceasing any further transmission of NFC data packets until the NFC session is reestablished. The NFC control module 220 can also start a timer. If the other device 250 reenters the communication range 120 before the timer reaches a threshold, e.g., ten seconds, the NFC control module 220 can reestablish the NFC session and continue sending and receiving the NFC data packets. If the other device 250 remains outside of the communication range 120 and the timer exceeds the threshold, the NFC control module 220 can end the NFC session. Further, the NFC control module 220 can provide an instruction to the user indicating a reentry direction. The term reentry direction can include a direction to move the mobile computing device 200 in order for the other device 250 to reenter the communication range 120. If the other device 250 reenters the communication range 120 after the timer exceeds the threshold, the NFC control module 220 may establish a new NFC session. In some embodiments, the NFC control module 220 may have to retransmit the NFC data packets that were sent in the previous NFC session.

The direction determination module 222 can determine the reentry direction upon the determination that the other device 250 has exited the communication range 120. In some embodiments, the direction determination module 222 can monitor the

NFC transceiver 216 and/or the accelerometer 218 to determine an exiting direction of the mobile computing device 200. The term exiting direction can include the direction that the mobile computing device 200 is traveling in relation to the other device 250 when the other device 250 exits the communication range 120. The direction determination module 222 can set the reentry direction equal to a direction that is substantially opposite to the exiting direction. The term substantially opposite to the exiting direction can include any angle that is within 45 degrees from a line that is opposite to the exiting direction.

The direction determination module 222 can determine the exiting direction in any suitable manner. In some embodiments, the direction determination module 222 determines the exiting direction by obtaining an accelerometer signal from the accelerometer 218 at the time when the NFC control module 220 determines that the other device 250 has exited the communication range 120. As should be appreciated, the direction indicated by the accelerometer signal when the other device 250 exits the communication range 120 is the exiting direction.

Additionally or alternatively, the direction determination module 222 can determine the exiting direction based on a signal strength at the NFC transceiver 216. In embodiments where the NFC transceiver 216 includes more than one antenna, the signal strength can include a first signal strength realized at a first antenna, and a second signal strength realized at a second antenna. In this manner, the direction determination module 222 can determine the exiting direction based on a first signal strength realized at a first antenna, a second signal strength realized at a second antenna, and a distance between the first antenna and the second antenna. As should be appreciated, the distance between the first antenna and the second antenna is a fixed distance. Thus, the direction determination module 222 can implement triangulation techniques to determine a location of the mobile computing device 200 relative to the other device 250 based on the first signal strength, the second signal strength, and the distance between the first and second antenna. As the mobile computing device 200 moves the first signal strength and/or the second signal may fluctuate. Using the triangulation techniques, the direction determination module 222 can determine the exiting direction based on the change in the first signal strength and/or the second signal strength when the NFC control module 220 determines that the other device 250 has exited the communication range 120.

The NFC control module 220 can obtain the reentry direction from the direction determination module 222 and can provide the instruction to the user to move the mobile computing device 200 in the reentry direction via the user interface 214. The instruction can be provided as a visual feedback, an audible feedback, and/or haptic feedback. For example, the NFC control module 220 can display an instruction indicating the direction to move the mobile computing device 200 and/or can vibrate the mobile computing device 200. In some embodiments, the user interface 214 may be configured to provide localized haptic feedback. In these embodiments, the NFC control module 220 can command the user interface 214 to vibrate a portion of the mobile computing device 200 corresponding to the reentry direction. For example, if the direction determination module 222 determines that the mobile computing device 200 should be moved to the left, the NFC control module 220 can command the user interface 214 to vibrate the left side of the mobile computing device 200.

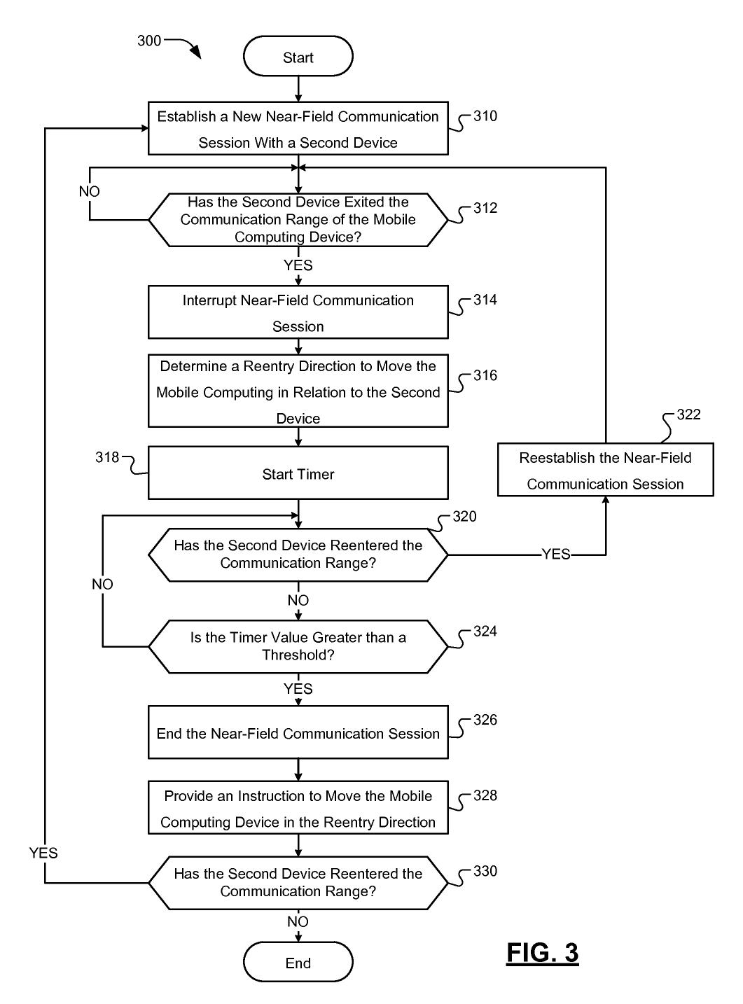

Referring now to FIG. 3, a flow chart depicting an example technique 300 for effectuating an NFC session is illustrated. For purposes of explanation, the technique 300 is described as being performed by components of the mobile computing device 200 depicted in FIG. 2. It should be appreciated, however, that other components may perform one or more of the operations described below.

At 310, the NFC control module 220 establishes an NFC session with a second device (e.g., the other device 250 of FIGS. 1 and 2). Once the NFC session is established, the mobile computing device 200 and the second device can exchange data with one another. At 312, the NFC control module 220 can determine whether the second device has exited the communication range 120 of the mobile computing device 200. If not, the devices can continue to exchange data. If the second device has exited the communication range 120 of the mobile computing device 200, the NFC control module 220 can interrupt the NFC session, as shown at 314.

At 316, the direction determination module 222 can determine a reentry direction. The mobile computing device 200 can determine the reentry direction by determining an exiting direction of the mobile computing device 200 when the second device exits the communication range 120. The direction determination module 222 can set the reentry direction equal to a direction that is substantially equal to the exiting direction.

At 318, the NFC control module 220 can start a timer. At 320, the NFC control module 220 can determine whether the second device has reentered the communication range 120. If the second device has reentered the communication range 120, the NFC control module 220 can reestablish the NFC session, as shown at 322. If the second device has not reentered the communication range 120, the NFC control module 220 determines whether the value of the timer exceeds a threshold as shown at 324. When the timer exceeds the threshold, the NFC control module 220 can end the NFC session, as shown at 326. At 328, the NFC control module 220 can also provide an instruction to move the mobile computing device 200 in the reentry direction. At 330, the NFC control module 220 can determine whether the second device has reentered the communication range 120. If the second device has reentered the communication range 120, the NFC control module 220 can establish a new NFC session, as shown at 310.

The technique 300 described above is provided for example only. Variations of the technique are contemplated and are within the scope of the disclosure. For example, in some embodiments, the NFC control module 220 may provide the instruction to move the mobile computing device 200 in the reentry direction when it determines that second device 250 has exited the communication range and before the timer exceeds the threshold. Further, some of the operations described may be performed in multiple operations, while other operations may be combined into a single operation.

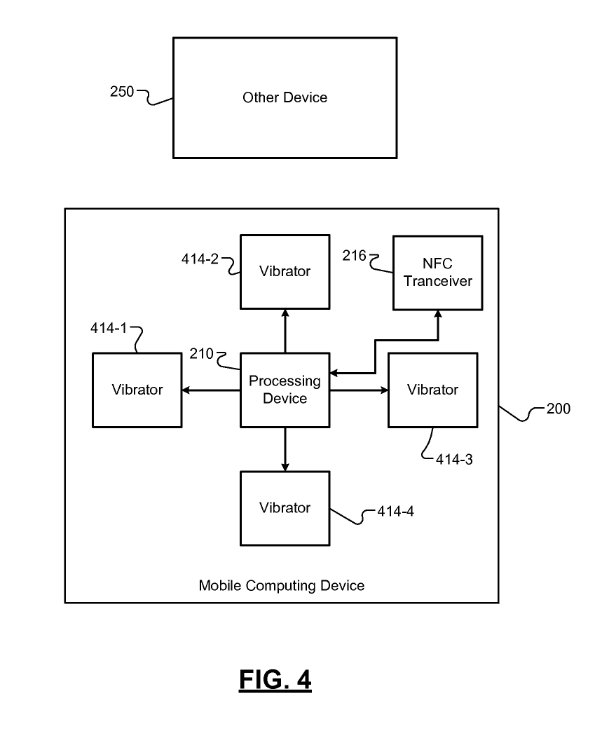

Referring now to FIG. 4, a functional block diagram of an example embodiment of the mobile computing device 200 is illustrated. In the example embodiment, the mobile computing device 200 is configured to provide localized haptic feedback. The mobile computing device 200 can include a plurality of vibrators, e.g., vibrator 414-1, vibrator 414-2, vibrator 414-3, and vibrator 414-4 (collectively referred to as vibrators 414) in communication with the processing device 210. It is noted that the vibrators 414 may be included in the user interface 214 of FIG. 2.

In this example, the processing device 210 can provide the instruction to move the mobile computing device 200 in the reentry direction by causing one or more of the vibrators 414 to vibrate. The processing device 210 can select which of the vibrators 414 to vibrate based on the reentry direction. For example, if the mobile computing device 200 is to be moved to the left, the processing device 210 can command vibrator 414-1 to vibrate. Similarly, if the mobile computing device 200 is to be moved towards the other device 250 and to the left, the processing device 210 can command the vibrator 414-1 and vibrator 414-2 to vibrate. While the example of FIG. 4 illustrates a plurality of vibrators 414, it is envisioned that other means for providing localized haptic feedback can be implemented in the mobile computing device 200.

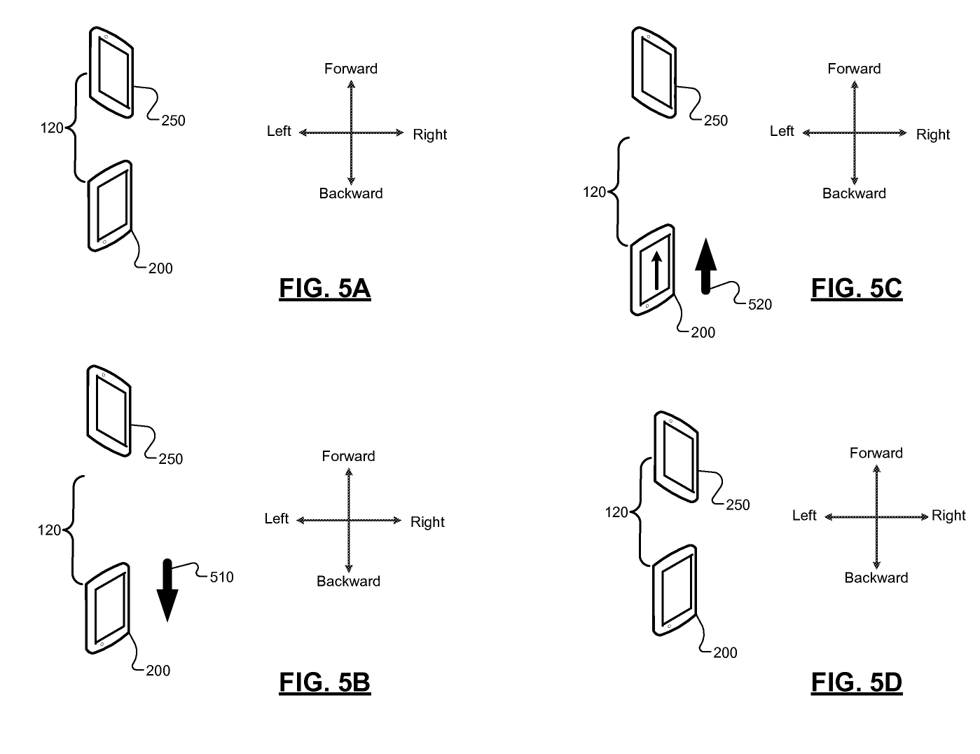

Referring now to FIGS. 5A-5D, schematics of an example of NFC are illustrated. In FIG. 5A, a mobile computing device 200 and another device 250 are engaged in NFC. As can be seen, the other device 250 is within the communication range 120. In FIG. 5B, the other device 250 has exited the communication range 120 of the mobile computing device 200. In the illustrated example, the mobile computing device 200 has been moved backwards. Thus, arrow 510 indicates that the exiting direction of the mobile computing device 200 is backwards. As was discussed, the mobile computing device 200 can determine a reentry direction based on the exiting direction. In FIG. 5C, the mobile computing device 200 is displaying a visual instruction to move the mobile computing device 200 in the reentry direction, i.e., forwards. Arrow 520 indicates the reentry direction. In FIG. 5D, the other device 250 has reentered the communication range 120 of the mobile computing device 200. Once this occurs the mobile computing device 200 can reestablish the NFC session or can establish a new NFC session.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known procedures, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The term “and/or” includes any and all combinations of one or more of the associated listed items. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

As used herein, the term module may refer to, be part of, or include: an Application Specific Integrated Circuit (ASIC); an electronic circuit; a combinational logic circuit; a field programmable gate array (FPGA); a processor or a distributed network of processors (shared, dedicated, or grouped) and storage in networked clusters or datacenters that executes code or a process; other suitable components that provide the described functionality; or a combination of some or all of the above, such as in a system-on-chip. The term module may also include memory (shared, dedicated, or grouped) that stores code executed by the one or more processors.

The term code, as used above, may include software, firmware, byte-code and/or microcode, and may refer to programs, routines, functions, classes, and/or objects. The term shared, as used above, means that some or all code from multiple modules may be executed using a single (shared) processor. In addition, some or all code from multiple modules may be stored by a single (shared) memory. The term group, as used above, means that some or all code from a single module may be executed using a group of processors. In addition, some or all code from a single module may be stored using a group of memories.

The techniques described herein may be implemented by one or more computer programs executed by one or more processors. The computer programs include processor-executable instructions that are stored on a non-transitory tangible computer readable medium. The computer programs may also include stored data. Non-limiting examples of the non-transitory tangible computer readable medium are nonvolatile memory, magnetic storage, and optical storage.

Some portions of the above description present the techniques described herein in terms of algorithms and symbolic representations of operations on information. These algorithmic descriptions and representations are the means used by those skilled in the data processing arts to most effectively convey the substance of their work to others skilled in the art. These operations, while described functionally or logically, are understood to be implemented by computer programs. Furthermore, it has also proven convenient at times to refer to these arrangements of operations as modules or by functional names, without loss of generality.

Unless specifically stated otherwise as apparent from the above discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system memories or registers or other such information storage, transmission or display devices.

Certain aspects of the described techniques include process steps and instructions described herein in the form of an algorithm. It should be noted that the described process steps and instructions could be embodied in software, firmware or hardware, and when embodied in software, could be downloaded to reside on and be operated from different platforms used by real time network operating systems.

The present disclosure also relates to an apparatus for performing the operations herein. This apparatus may be specially constructed for the required purposes, or it may comprise a general-purpose computer selectively activated or reconfigured by a computer program stored on a computer readable medium that can be accessed by the computer. Such a computer program may be stored in a tangible computer readable storage medium, such as, but is not limited to, any type of disk including floppy disks, optical disks, CD-ROMs, magnetic-optical disks, read-only memories (ROMs), random access memories (RAMs), EPROMs, EEPROMs, magnetic or optical cards, application specific integrated circuits (ASICs), or any type of media suitable for storing electronic instructions, and each coupled to a computer system bus. Furthermore, the computers referred to in the specification may include a single processor or may be architectures employing multiple processor designs for increased computing capability.

The algorithms and operations presented herein are not inherently related to any particular computer or other apparatus. Various general-purpose systems may also be used with programs in accordance with the teachings herein, or it may prove convenient to construct more specialized apparatuses to perform the required method steps. The required structure for a variety of these systems will be apparent to those of skill in the art, along with equivalent variations. In addition, the present disclosure is not described with reference to any particular programming language. It is appreciated that a variety of programming languages may be used to implement the teachings of the present disclosure as described herein, and any references to specific languages are provided for disclosure of enablement and best mode of the present invention.

The present disclosure is well suited to a wide variety of computer network systems over numerous topologies. Within this field, the configuration and management of large networks comprise storage devices and computers that are communicatively coupled to dissimilar computers and storage devices over a network, such as the Internet.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

1. A computer-implemented method, comprising:
establishing, at a mobile computing device having one or more processors, a near-field communication (NFC) session with a second device when the second device is within a communication range of the mobile computing device that is appropriate for NFC transmissions between the mobile computing device and the second device;
monitoring, at the mobile computing device, a signal strength between an NFC transceiver of the mobile computing device and the second device;
based on the signal strength, detecting, at the mobile computing device, whether the second device has exited the communication range of the mobile computing device; and
in response to detecting that the second device has exited the communication range of the mobile computing device:
a) interrupting, at the mobile computing device, the NFC session,
b) based on at least one of (i) the signal strength and (ii) an accelerometer signal output by an accelerometer of the mobile computing device, determining, at the mobile computing device, an exiting direction of the second device from the communication range of the mobile computing device,
c) based on the exiting direction, determining, at the mobile computing device, a reentry direction to move the mobile computing device in relation to the second device in order to bring the second device back within the communication range of the mobile computing device,
d) starting, at the mobile computing device, a timer,
e) based on the signal strength, determining, at the mobile computing device, whether the second device reenters the communication range of the mobile computing device before the timer exceeds a threshold, and
f) providing, at the mobile computing device, an instruction to a user to move the mobile computing device in the reentry direction when the second device has not reentered the communication range of the mobile computing device and the timer exceeds the threshold, wherein the instruction is indicative of the reentry direction.

2. The method of claim 1, further comprising reestablishing, at the mobile computing device, the NFC session when the second device reenters the communication range of the mobile computing device before the timer exceeds the threshold.

3. The method of claim 1, further comprising establishing, at the mobile computing device, a new NFC session with the second device when the second device reenters the communication range of the mobile computing device after the timer exceeds the threshold.

4. The method of claim 1, wherein the reentry direction is determined based on the signal strength at the NFC transceiver of the mobile computing device when the second device exits the communication range of the mobile computing device.

5. The method of claim 1, wherein the exiting direction is determined based on the acceleration signal output by the accelerometer of the mobile computing device when the second device exits the communication range.

6. The method of claim 1, wherein the reentry direction is set equal to a direction that is substantially opposite to the exiting direction.

7. The method of claim 4, wherein:
the NFC transceiver includes a first NFC antenna and a second NFC antenna,
the signal strength at the NFC transceiver includes a first signal strength at the first NFC antenna and a second signal strength at the second NFC antenna, and
the reentry direction is further based on the first signal strength, the second signal strength, and a distance between the first NFC antenna and the second NFC antenna.

8. The method of claim 7, wherein the exiting direction is determined based on changes in at least one of the first signal strength and the second signal strength when the second device exits the communication range of the mobile computing device.

9. The method of claim 1, wherein the instruction is provided as localized haptic feedback, such that providing the instruction includes:
determining, at mobile computing device, a section of the mobile computing device at which to provide the localized haptic feedback indicative of the reentry direction; and
providing, at the mobile computing device, the localized haptic feedback at the section.

10. A mobile computing device, comprising:
a near-field communication (NFC) transceiver configured to generate an electromagnetic field used to perform NFC with a second device;
an NFC control module configured to:
establish an NFC session with the second device when the second device is within a communication range of the NFC transceiver that is appropriate for NFC transmissions between the mobile computing device and the second device;
monitor a signal strength between the NFC transceiver and the second device:
based on the signal strength, detect whether the second device has exited the communication range of the NFC transceiver; and
in response to detecting that the second device has exited the communication range of the NFC transceiver:
a) interrupt the NFC session,
b) start a timer,
c) based on the signal strength, determine whether the second device reenters the communication range of the NFC transceiver before the timer exceeds a threshold, and
d) provide an instruction to a user to move the mobile computing device in a reentry direction when the second device has not reentered the communication range of the NFC transceiver and the timer exceeds the threshold, wherein the instruction is indicative of the reentry direction; and
a direction determination module configured to:
a) when the second device is determined to have in response to detecting that the second device has exited the communication range of the NFC transceiver and based on at least one of (i) the signal strength and (ii) an accelerometer signal output by an accelerometer of the mobile computing device, determine the exiting direction of the second device from the communication range of the NFC transceiver, and
b) based on the exiting direction, determine the reentry direction to move the mobile computing device in relation to the second device in order to bring the second device back within the communication range of the NFC transceiver.

11. The mobile computing device of claim 10, wherein the NFC control module is further configured to reestablish the NFC session when the second device reenters the communication range of the NFC transceiver before the timer exceeds the threshold.

12. The mobile computing device of claim 10, wherein the NFC control module is further configured to establish a new NFC session with the second device when the second device reenters the communication range of the NFC transceiver after the timer exceeds the threshold.

13. The mobile computing device of claim 10, wherein the direction determination module determines the reentry direction based on the signal strength at the NFC transceiver when the second device exits the communication range of the NFC transceiver.

14. The mobile computing device of claim 11, further comprising the accelerometer that outputs the accelerometer signal, wherein the direction determination module determines the exiting direction based on the accelerometer signal.

15. The mobile computing device of claim 10, wherein the reentry direction is a direction that is substantially opposite to the exiting direction.

16. The mobile computing device of claim 13, wherein:
the NFC transceiver includes a first NFC antenna and a second NFC antenna;
the signal strength at the NFC transceiver includes a first signal strength at the first NFC antenna and a second signal strength at the second NFC antenna; and
the direction determination module is configured to determine the reentry direction further based on the first signal strength, the second signal strength, and a distance between the first NFC antenna and the second NFC antenna.

17. The mobile computing device of claim 16, wherein the reentry direction is a direction that is substantially opposite to the exiting direction.

18. The mobile computing device of claim 11, further comprising a plurality of vibrators, each vibrator located at a different portion of the mobile computing device, wherein the NFC control module provides the instruction to move the mobile computing device in the reentry direction by:
selecting one of the plurality of vibrators indicative of the reentry direction; and
commanding the selected vibrator to vibrate.

19. A computer-implemented method, comprising:
establishing, at a mobile computing device having a processing device, a near-field communication (NFC) session with a second device when the second device is within a communication range of the mobile computing device;
monitoring, at the mobile computing device, a signal strength between an NFC transceiver of the mobile computing device and the second device;
based on the signal strength, detecting, at the mobile computing device, whether the second device has exited the communication range of the mobile computing device; and
in response to detecting that the second device has exited the communication range of the mobile computing device:
a) interrupting, at the mobile computing device, the NFC session,
b) based on the at least one of (i) the signal strength and (ii) an accelerometer signal output by an accelerometer of the mobile computing device, determining, at the mobile computing device, an exiting direction of the second device from the communication range with the mobile computing device,
c) based on the exiting direction, determining, at the mobile computing device, a reentry direction to move the mobile computing device in relation to the second device in order to bring the second device back within the communication range of the mobile computing device, and
d) providing, at the mobile computing device, an instruction to a user to move the mobile computing device in the reentry direction when the second device has not reentered the communication range and the timer exceeds the threshold, wherein the instruction is indicative of the reentry direction.

20. The method of claim 19, further comprising:
starting, at the mobile computing device, a timer when the second device is determined to have exited the communication range of the mobile computing device;
based on the signal strength, determining, at the mobile computing device, whether the second device reenters the communication range of the mobile computing device before the timer exceeds a threshold;
reestablishing, at the mobile computing device, the NFC session when the second device reenters the communication range of the mobile computing device before the timer exceeds the threshold; and
establishing, at the mobile computing device, a new NFC session with the second device when the second device reenters the communication range of the mobile computing device after the timer exceeds the threshold.
